(19) United States
(12) Patent Application Publication
(10) Pub. No.: US 2025/0277357 A1
(43) Pub. Date: Sep. 4, 2025

(54) WORKSTATION SINKS AND ACCESSORIES

(71) Applicant: Kohler Co., Kohler, WI (US)

(72) Inventors: Ryan Detlaff, Kohler, WI (US); Karl Hinkfuss, Kohler, WI (US)

(21) Appl. No.: 19/048,818

(22) Filed: Feb. 7, 2025

Related U.S. Application Data
(60) Provisional application No. 63/557,273, filed on Feb. 23, 2024.

(51) Int. Cl. E03C 1/186; A47J 43/24; A47J 43/28; A47J 47/00; A47J 47/16; A47J 47/18; A47J 47/20; A47L 19/04; E03C 1/182; F25C 5/182

(52) U.S. Cl. CPC E03C 1/186; A47J 43/24; A47J 43/283; A47J 47/005; A47J 47/16; A47J 47/18; A47J 47/20; A47L 19/04; F25C 5/182; E03C 1/182

(57) ABSTRACT

The present disclosure generally relates to workstation sinks and related accessories. More specifically, the present disclosure relates to workstation sinks designed for use with several different sink and kitchen accessories to create a functional sink workplace. One example is a workstation sink system having a faucet, a basin, and one or more accessories configured for use in the basin or neighboring countertops and ledges. Another example is a workstation sink accessory kit containing two or more accessories for use with a basin or neighboring countertops and ledges. A user may select any number of accessories their particular kitchen and sink needs.

### RELATED APPLICATIONS

The present application claims the benefit of U.S. Provisional Application Ser. No. 63/557,273, filed Feb. 23, 2024, which is hereby incorporated by reference in its entirety.

### TECHNICAL FIELD

The present disclosure generally relates to workstation sinks and related accessories. More specifically, the present disclosure relates to workstation sinks designed for use with sink and kitchen accessories to create a functional sink workplace.

### BACKGROUND

Sinks are often used in kitchens along with countertops, cutting boards, colanders, wash basins, and other related accessories for the preparation of food or drink items and for cleaning dishes and other kitchen utensils. It can be difficult to combine a sink and faucet with various kitchen accessories to create a single functional workplace. Difficulties arise based on kitchen size restrictions, material constraints, and lack of overall compatibility between various accessories such as cutting boards and wash basins. New workstation sinks and related accessories are thus needed to remedy issues associated with conventional sink-faucet-accessory combinations. The present disclosure addresses this need through description of various workstation sinks, workstation sinks systems, related workstation sink accessories, and workstation sink accessory kits intended to create a functional sink workplace suitable to a variety of user needs and kitchen scenarios (e.g., prepping food and drinks, storing food and drinks, cleaning dishes and kitchen utensils, etc.).

### SUMMARY

Examples of the present disclosure relate, in part, to workstation sink systems that improve the kitchen experience by providing a single functional sink workplace suitable to a variety of user needs and kitchen scenarios. Examples disclosed herein enable users to personalize their kitchen experience without adding clutter to sinks or neighboring countertops, improve the usability of various kitchen and sink accessories by placing them near each other and near a faucet and sink, and provide aesthetically desirable scenes to the kitchen setting. Other advantages of the present disclosure over conventional designs will become apparent in subsequent sections.

In an example, a workstation sink system may include a faucet, a basin, and one or more accessories for use with the faucet and the basin. In an example, the one or more accessories may include a first sink cover having one or more openings for receiving fluids and debris, a second sink cover having one or more openings for receiving fluids and debris, a colander having ridges for storing items and openings defined in the ridges for receiving fluids and debris, a bucket for storing items such as ice and bottles, the bucket having a corresponding lid and a pair of tongs couplable to the lid, and a drain cover configured to cover a wash basin drain or sink basin drain hole but still allow for fluids and debris to be removed through the drain hole. In an example, two or more accessories may be combined into a workstation sink accessory kit for use in a kitchen setting.

The above summary is not intended to describe each illustrated example or every implementation of the subject matter hereof. The figures and the detailed description that follow more particularly exemplify various examples.

### BRIEF DESCRIPTION OF THE DRAWINGS

The disclosure may be more completely understood in consideration of the following detailed description of examples of the disclosure in connection with the accompanying drawing, in which:

FIG. 1A is a perspective view of a first sink cover, according to an example of the present disclosure.

FIG. 1B is a bottom view of the first sink cover of FIG. 1A.

FIG. 2A is a perspective view of a second sink cover, according to an example of the present disclosure.

FIG. 2B is a bottom view of the second sink cover of FIG. 2A.

FIG. 3A is a perspective view of a colander, according to an example of the present disclosure.

FIGS. 3B and 3C are side and front views, respectively, of the colander of FIG. 3A.

FIGS. 3D and 3E are top and bottom views, respectively, of the colander of FIG. 3A.

FIG. 4A is a perspective view of a bucket, according to an example of the present disclosure.

FIGS. 4B, 4C, and 4D are side, top, and bottom views, respectively, of the bucket of FIG. 4A.

FIG. 4E is an exploded view of the bucket of FIG. 4A.

FIG. 5A is a perspective view of a drain cover, according to an example of the present disclosure.

FIGS. 5B, 5C, and 5D are bottom, side, and tilted views of the drain cover of FIG. 5A.

FIGS. 6A-6I are perspective views of a workstation sink with accessories, according to examples of the present disclosure.

FIG. 7 is a perspective view of a workstation sink, according to an example of the present disclosure.

FIGS. 8A and 8B are product views of workstation sink accessory kits, according to examples of the present disclosure.

While various examples are amenable to various modifications and alternative forms, specifics thereof have been shown by way of example in the drawings and will be described in detail. It should be understood, however, that the intention is not to limit the claimed inventions to the particular examples described. On the contrary, the intention is to cover all modifications, equivalents, and alternatives falling within the spirit and scope of the subject matter as defined by the claims.

### DETAILED DESCRIPTION OF THE DRAWINGS

The following detailed description should be read with reference to the drawings in which similar elements in different drawings are numbered the same. The drawings, which are not necessarily to scale, depict illustrative examples and are not intended to limit the scope of the disclosure.

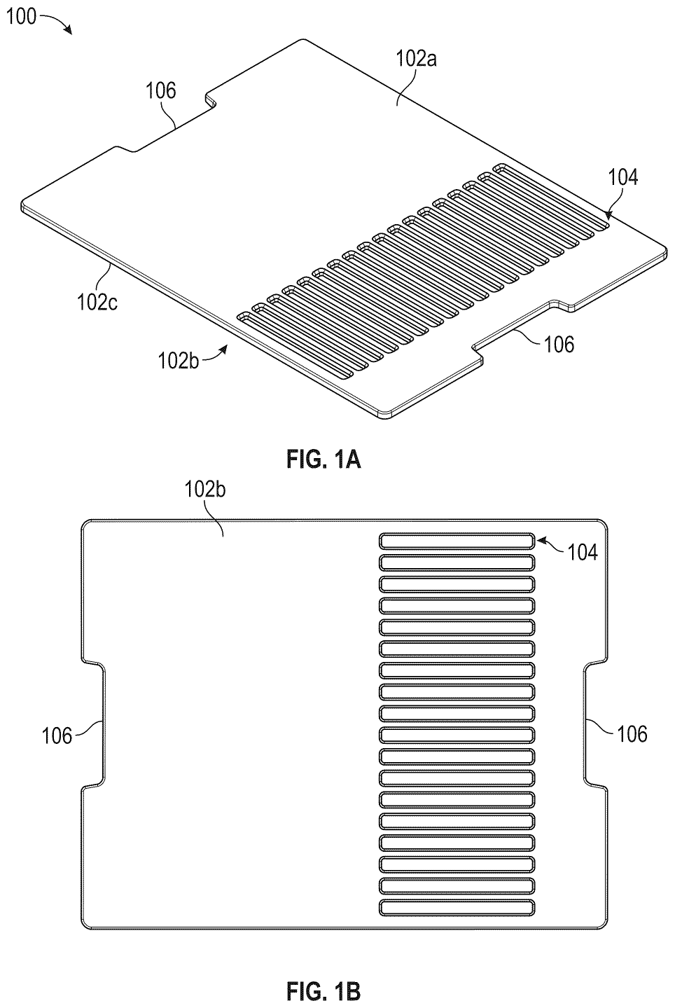

Referring generally to FIGS. 1A and 1B, a first sink cover 100 may include a top side 102a separated from a bottom side 102b by a perimeter edge 102c to form a generally rectangular shape. The distance between top and bottom sides 102a,b defined by perimeter edge 102c can be in the range of 1/32 inches to 1 inch, for example. In other contemplated examples, first sink cover 100 may comprise geometric configurations such as circular, triangular, other regular polygonal shapes, or irregular polygonal shapes. First sink cover 100 may include one or more openings 104 defined between the top side 102a and the bottom side 102b. The one or more openings 104 may comprise 18 individual openings 104 as illustrated in the figures, or any number of openings 104 less than or greater than 18. For example, first sink cover 100 may include two or three rows of openings 104 defined in an ordered or irregular pattern between top and bottom sides 102a,b. The one or more openings 104 can be slotted openings arranged in horizontal, vertical, diagonal, or irregular patterns along top side 102a.

The one or more openings 104 can be positioned in any suitable location along top side 102a, for example along a middle portion, a left-side portion, or a right-side portion of top side 102a. As illustrated in FIGS. 1A and 1B, the one or more openings 104 can be slotted openings arranged in a horizontal pattern along a right-side portion of top side 102a (or left-side portion depending on the perspective of the viewer). In other contemplated examples, one or more of the one or more openings 104 can be arranged irregularly along top side 102a with respect to any other one or more openings 104. For example, a first opening 104 can be arranged at a diagonal, a second opening 104 can be arranged horizontally, and a third opening 104 can be arranged vertically. Other openings 104 can be arranged in a combination of diagonal, horizontal, or vertical patterns with respect to any other openings 104 defined in top side 102a. The one or more openings 104 can have any suitable length to width ratio, for example ratios between 1:1 and 10:1. The one or more openings 104 can have chamfered, filleted, or beveled edges between the top and bottom sides 102a,b, to minimize splashing when first sink cover 100 is used with a faucet.

First sink cover 100 may include a pair of cutouts 106 defined on opposing sides (e.g., cutout 106 defined between top and bottom sides 102a,b on a right side of first sink cover 100 with another cutout 106 defined on the opposing left side of first sink cover 100). The pair of cutouts 106 may have a generally rectangular shape with rounded edges, or any other suitable regular or irregular polygonal shape (e.g., circular, triangular, oval, etc.). The pair of cutouts 106 may have a variety of suitable lengths and widths, such as lengths and widths in the range of 1/32 inches to 5 inches, for example. A length of the pair of cutouts 106 may be oriented perpendicular or parallel to the one or more openings 104, or at an angle if the one or more openings 104 are oriented diagonally. The pair of cutouts 106 may be oriented along a central axis of first sink cover 100, or offset from the central axis by a distance (i.e., the pair of cutouts 106 can be off center rather than generally centered as illustrated in the figures).

First sink cover 100 can comprise a variety of suitable lengths and widths configured to match corresponding sink basin lengths. For example, first sink cover 100 may have a length of approximately 23 inches, approximately 29 inches which can leave a gap for access to a sink, or approximately 33 inches to allow for use with a separate accessory such as a cutting board. Two first sink covers 100 having a combined length of approximately 44 inches may be used to completely cover a sink having a length equal to or approximately 44 inches. As the name suggests, first sink cover 100 may cover the basin portion of a sink while allowing fluids from a faucet or other materials to pass through the one or more openings 104 during use. First sink cover 100 advantageously provides a flat surface portion for the placement of items such as cooking utensils, dishes, or food and drink items while still enabling access to the sink basin via the one or more openings 104. First sink cover 100 may be manufactured from a variety of materials including, but not limited to, polymers such as polypropylene and polyethylene, wood materials and wood composites, marble, ceramics, metals, RICHLITE, which is a paper-based material manufactured by the Richlite Company, or combinations thereof.

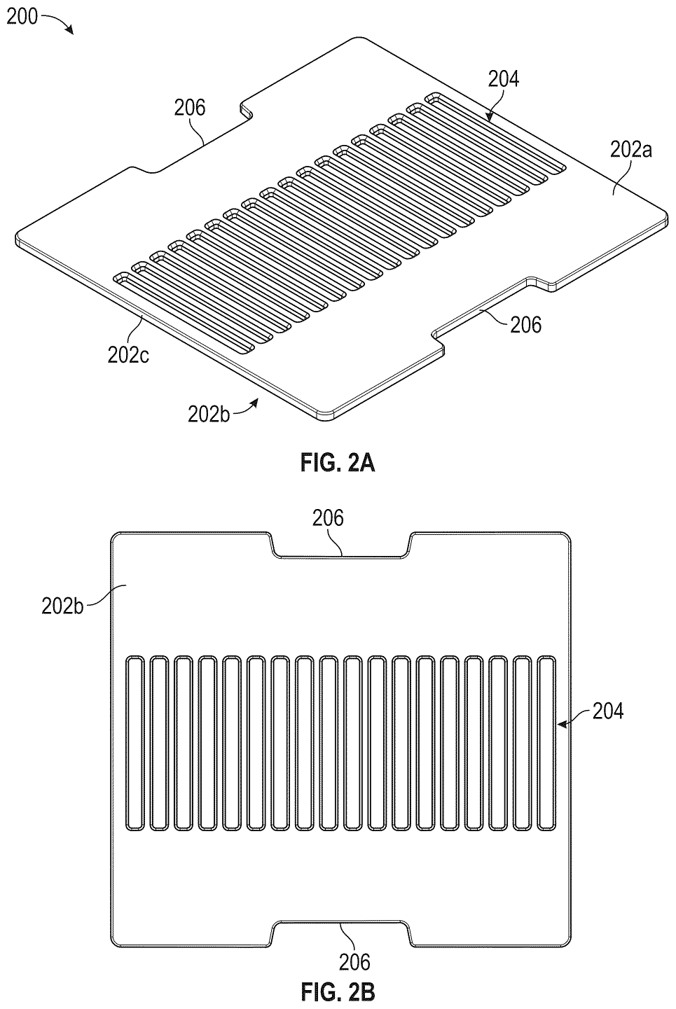

Referring now generally to FIGS. 2A and 2B, second sink cover 200 may include a top side 202a separated from a bottom side 202b by a perimeter edge 202c to form a polygonal shape such as a generally rectangular shape. Second sink cover 200 may further include one or more openings 204 defined between the top side 202a and the bottom side 202b, and a pair of cutouts 206 defined on opposing sides (e.g., cutout 206 defined between top and bottom sides 202a,b on a right side of second sink cover 200 with another cutout 206 defined on the opposing left side of second sink cover 200). The one or more openings 204 may be arranged along a middle portion of top side 202a in a vertical orientation as illustrated in the figures. In a contemplated example, the one or more openings 204 can be chamfered or filleted (i.e. includes a chamfer edge or fillet edge) to minimize splashing when second sink cover 200 is used with a faucet.

Second sink cover 200 has many similarities to first sink cover 100, and for simplicity the description of common components is not repeated entirely herein. Like reference numerals and feature names may designate like features names throughout that are corresponding or analogous. Second sink cover 200 may include the same geometrical configurations, orientations, shapes, measurements, and materials as first sink cover 100. Like first sink cover 100, second sink cover 200 may be configured for use with a sink to enable fluids or other materials to pass through the one or more openings 204 into the sink basin. Second sink cover 200 likewise advantageously provides a flat surface portion for the placement of items while still enabling access to the sink basin during use via the one or more openings 204. Like that of first sink cover 100, the geometry of the flat surface portion is determined largely by the number and orientation of the one or more openings 204 defined between the top and bottom sides 202a,b of the second sink cover 200.

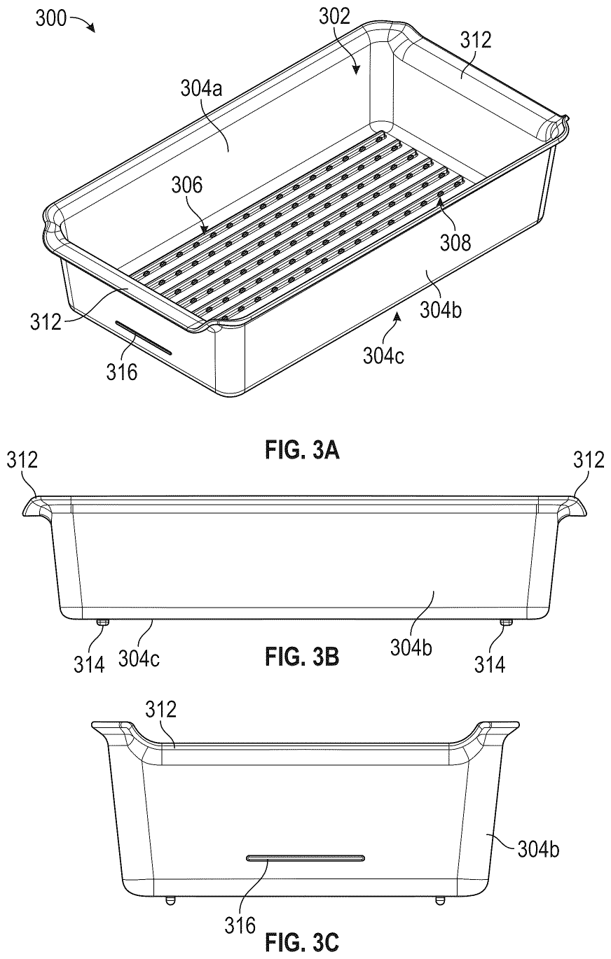

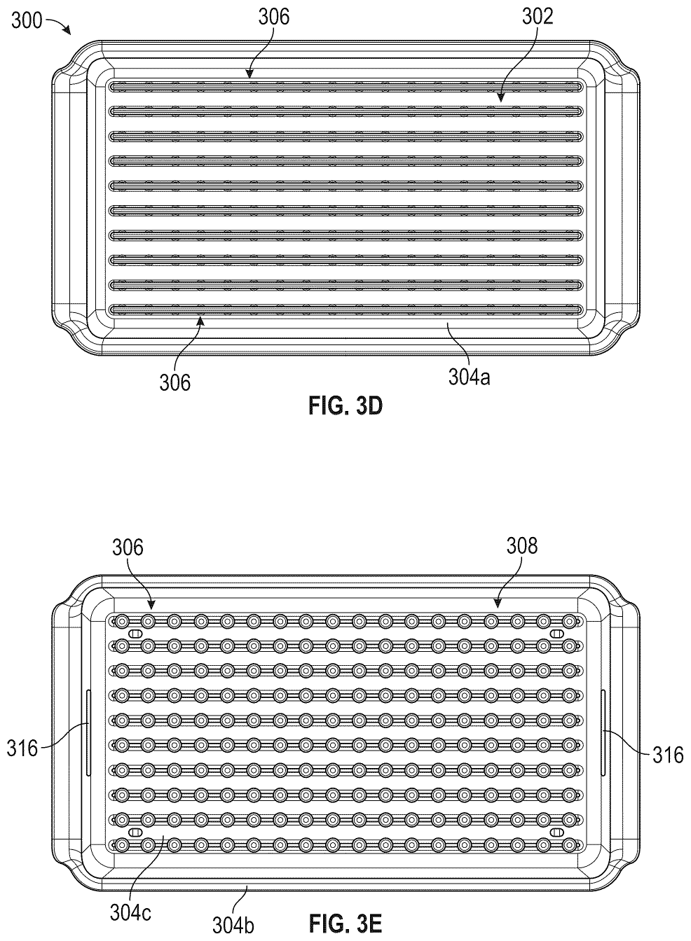

Referring now generally to FIGS. 3A-3E, a colander 300 may include a basin 302 defining an inner perimeter wall 304a and a floor surface, an outer perimeter wall 304b opposite the inner perimeter wall 304a, and a bottom side 304c opposite the floor surface of the basin 302. Colander 300 may further include one or more ridges 306 defined in the floor surface of the basin 302. The one or more ridges 306 may define one or more openings 308 extending from the one or more ridges 306 to the bottom side 304c of the colander 300. Colander 300 may further include a pair of ledges 312 arranged opposite each other on opposing sides of the inner perimeter wall 304a. In a contemplated example, the pair of ledges 312 may extend completely around a top portion of the inner perimeter wall 304a. Colander 300 may further include one or more feet 314 couplable to the bottom side 304c, and a pair of external openings 316 defined opposite each other on opposing sides of the inner perimeter wall 304a (this may be the same opposing sides as pair of ledges 312 or different sides of colander 300). The pair of external openings 316 may extend from the inner perimeter wall 304a to the outer perimeter wall 304b in a contemplated example.

The one or more ridges 306 of colander 300 may be formed in any suitable pattern such as horizontal, vertical, or diagonal with respect to the basin 302 floor surface. As illustrated particularly in FIGS. 3D and 3E, the one or more ridges 306 can be slotted and arranged in a horizontal pattern parallel with the length of the basin 302. In other contemplated examples, one or more of the one or more ridges 306 can be arranged irregularly along the basin 302 floor surface with respect to any other one or more ridges 306. For example, a first ridge 306 can be arranged at a diagonal, a second ridge 306 can be arranged horizontally, and a third ridge 306 can be arranged vertically, all with respect to the basin 302 floor surface. The one or more ridges 306 may be approximately evenly divided or dispersed at different distances apart. Each ridge 306 may define one or more openings 308 equally spaced apart or at different distances apart. As illustrated in FIGS. 3D and 3E, the ridges 306 and the openings 308 are generally spaced approximately equal distances apart with the feet 314 separating the outermost and next outermost ridges 306 on the bottom side 304c.

In a contemplated example, the edges of inner and outer perimeter walls 304a,b of colander 300 may be rounded as illustrated in the figures. In a contemplated example, the pair of ledges 312 and the remaining top portion of the inner perimeter wall 304a may be rounded or chamfered as illustrated in the figures. Colander 300 may have a length approximately equal to the width of a sink basin so that colander 300 can fit inside the basin. For example, colander 300 can be configured for use with sinks ranging from approximately 23 inches to approximately 44 inches in width, for example, or sinks with widths less than or greater than this range. Colander 300 may be manufactured from a variety of materials including, but not limited to, polymers, wood materials and wood composites, marble, ceramics, metals, paper-based materials such as Richlite®, or combinations thereof.

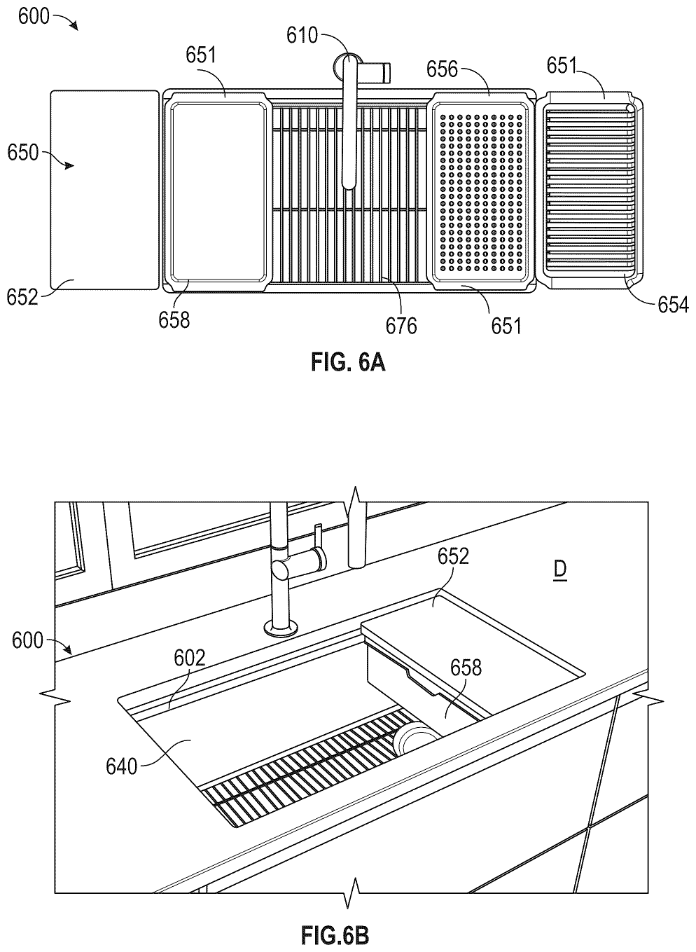

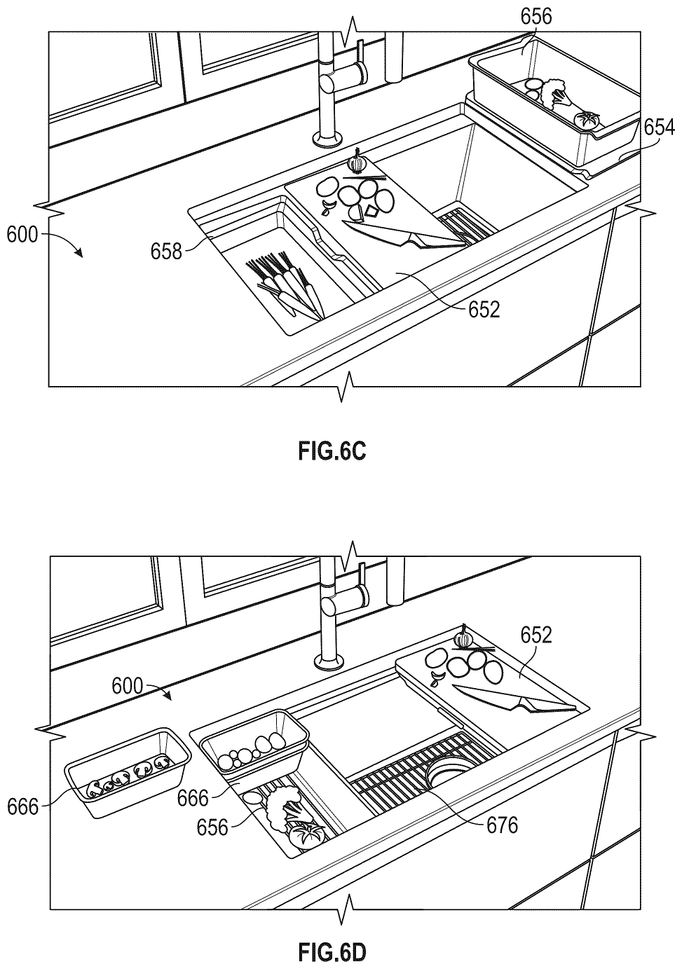

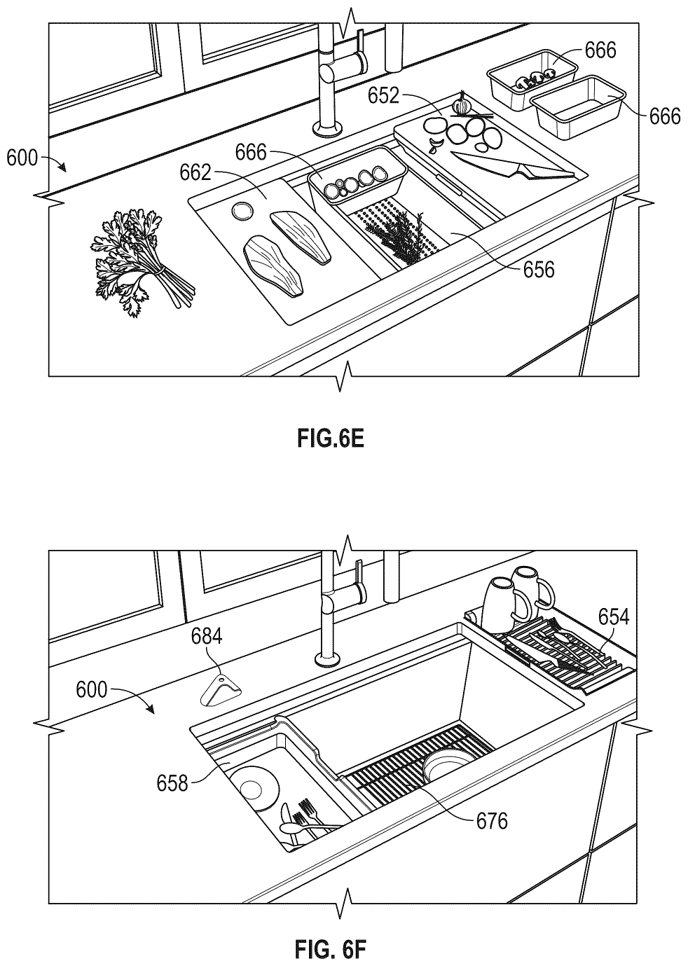

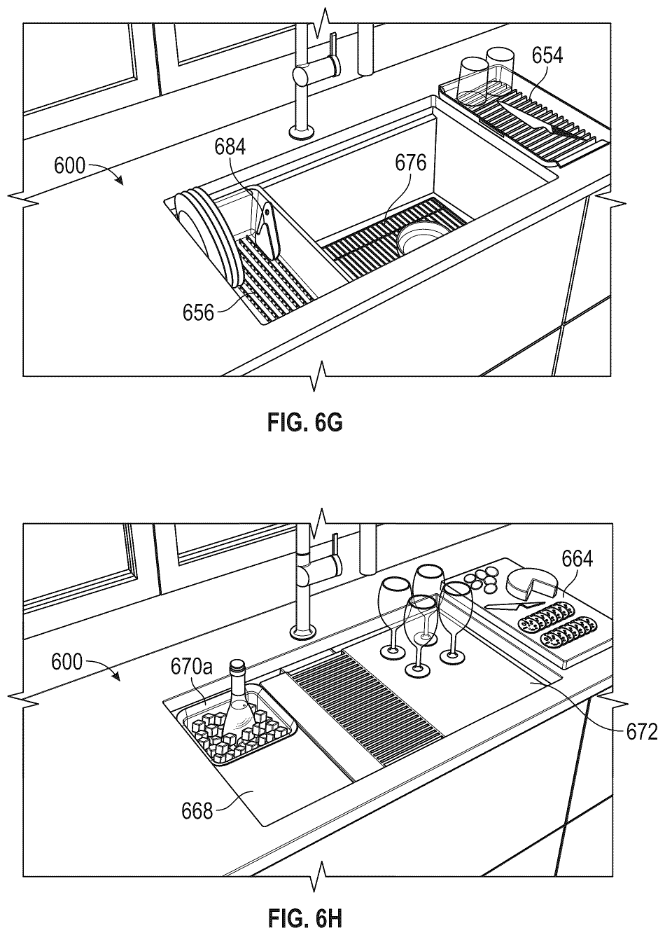

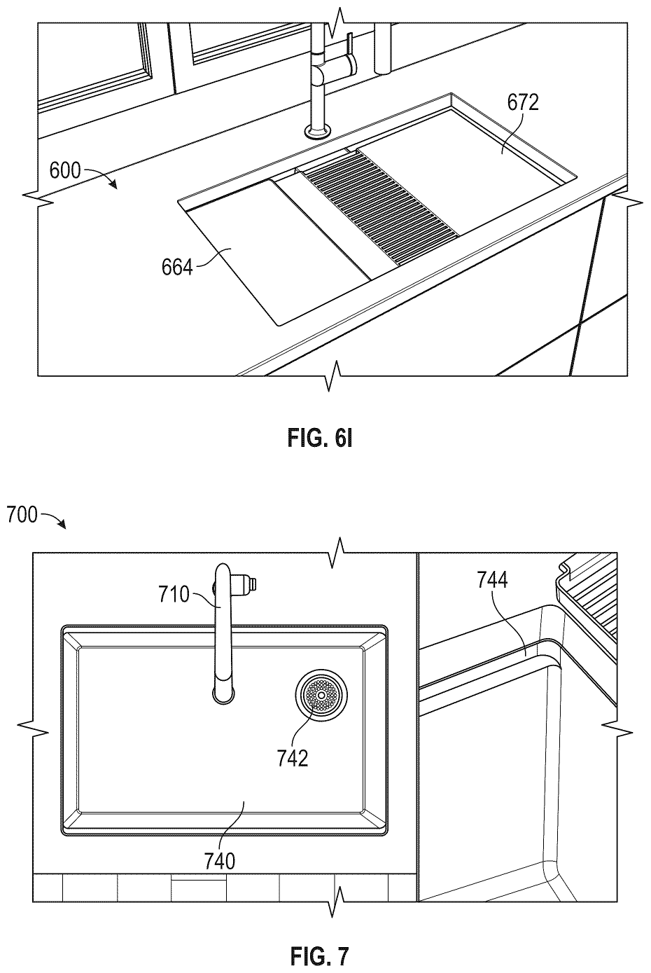

Advantageously, colander 300 can be configured for use both inside a sink basin and with a drain board placed on a countertop near the sink, as illustrated particularly in FIG. 6C with corresponding colander 656 (i.e., colander 656 can be equivalent to colander 300). Because colander 300 has one or more ridges 306 defining one or more openings 308, it can function additionally as a drying rack for dishes and other kitchen utensils by allowing fluids to exit the colander 300 through the one or more openings 308. For example, FIG. 6G illustrates corresponding colander 656 having several dishes and kitchen utensils placed in ridges defined in the floor surface of the colander basin. Colander 656 enables drying of the dishes and kitchen utensils because the ridges each define several openings through which washing fluid, such as water, can exit the colander basin. As such, colander 300/656 is a multifunctional structure configured for several different uses inside or outside of a sink basin.

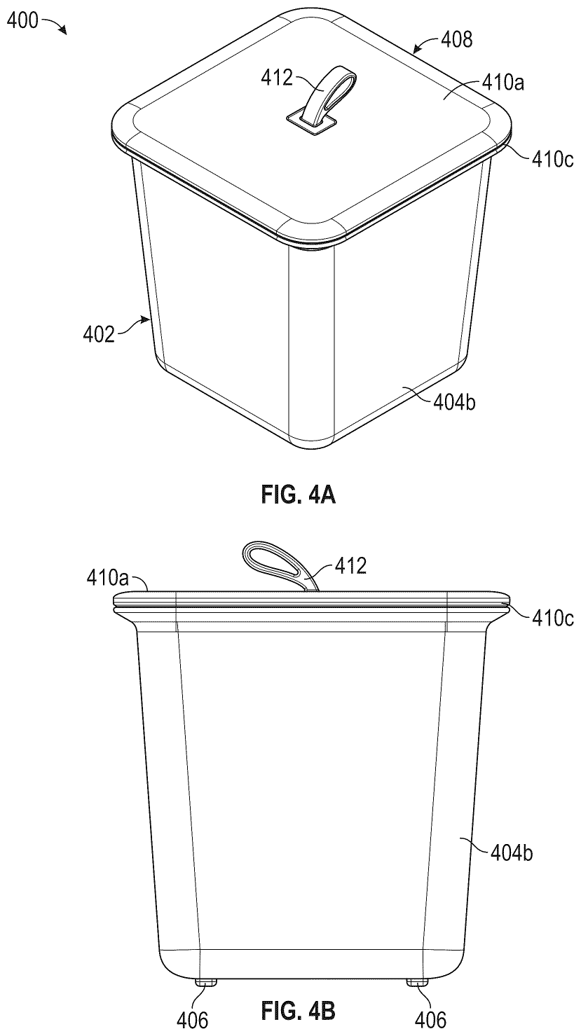

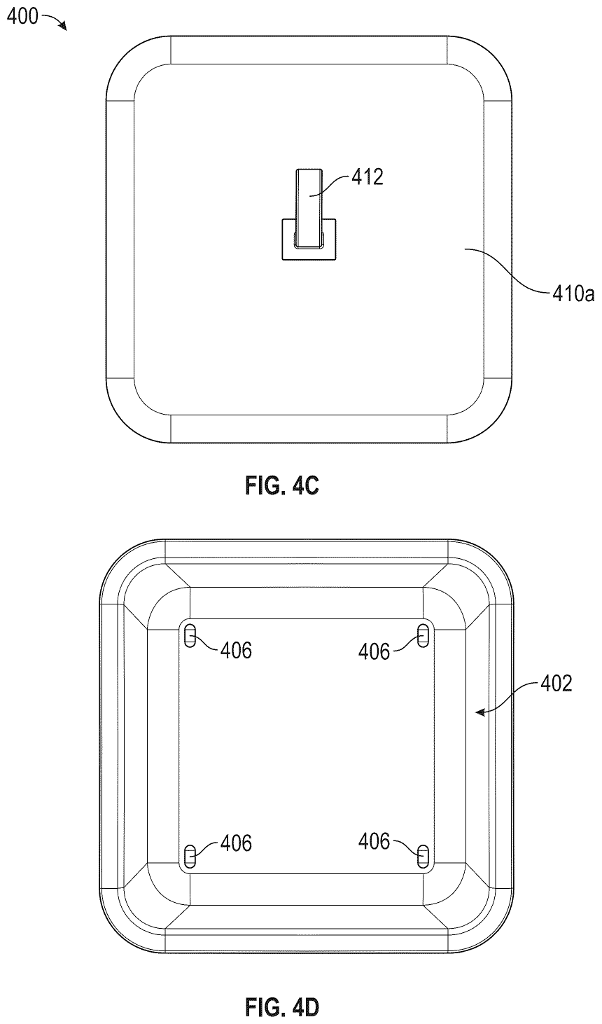

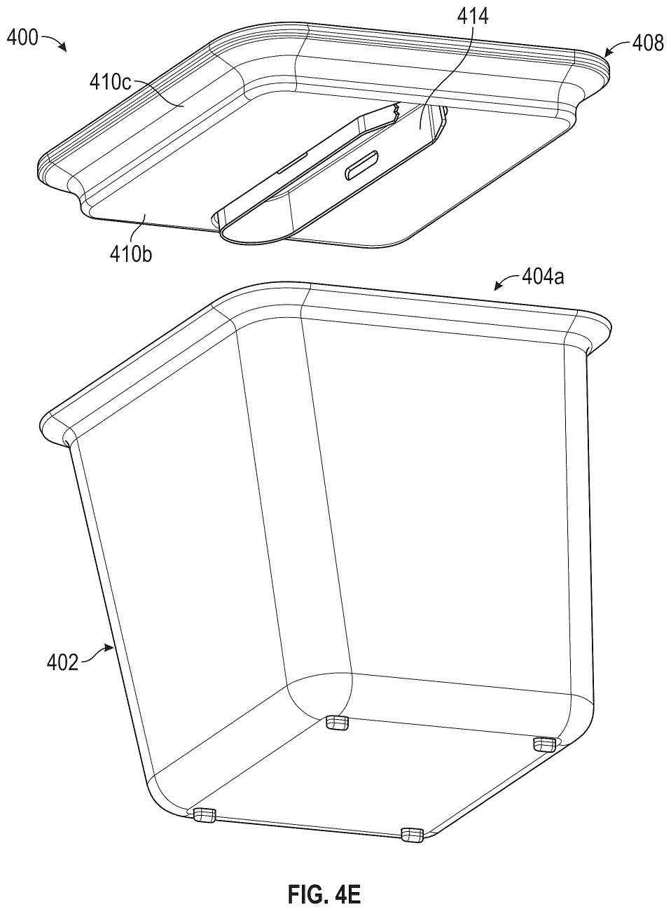

Referring now generally to FIGS. 4A-4E, a bucket 400 for storing ice or other items may include a housing 402 having an inner perimeter wall 404a separated from an outer perimeter wall 404b by a thickness, and one or more feet 406 on a bucket bottom surface. The bucket 400 may further include a lid 408 couplable to a top surface of the housing 402, the lid 408 being defined by a top surface 410a separated from a bottom surface 410b by a perimeter edge 410c. Bucket 400 may further include a strap 412 couplable to the top surface 410a of the lid 408, and a pair of tongs 414 for grabbing ice or other items stored inside the housing 402, the pair of tongs 414 being couplable to the bottom surface 410b of the lid 408 as illustrated in the exploded view of FIG. 4E.

In a contemplated example, bucket 400 may have a generally rectangular structure with rounded edges. In other contemplated examples, bucket 400 may have a cylindrical structure, a spherical structure, a different regular polygonal structure, or an irregular polygonal structure. Bucket 400 can be received within a bucket frame positioned in a sink basin as discussed in a subsequent section. Bucket 400 may be manufactured from a variety of materials including, but not limited to, polymers, wood materials and wood composites, marble, ceramics, metals, paper-based materials such as RICHLITE, or combinations thereof.

The combination of inner perimeter wall 404a, outer perimeter wall 404b, and bucket bottom surface create an interior space for bucket 400 with one end closed (i.e., the bucket bottom surface end) and another end open for receiving items. The interior space can be configured to receive a portion of lid 408 formed by bottom surface 410b and perimeter edge 410c therein. To achieve this, the area of bottom surface 410b and perimeter edge 410c is approximately the same as the area of inner perimeter 404a such that lid 408 can be securely and removably received within housing 402. The pair of tongs 414 may also be received within housing 402 when lid 408 is coupled (i.e., securely and removably received) to housing 402.

When lid 408 is removed from housing 402, the pair of tongs 414 can be decoupled from lid 408 and used to remove items from, or add items to, the interior space of housing 402. Bucket 400 thus advantageously provides a storage device with an integrated pair of tongs 414 that can be coupled to and decoupled from the removable lid 408 using any suitable mechanism (e.g., fasteners, adhesives, straps, magnetics, holding structure, etc.). In a contemplated example, bottom surface 410a of lid 408 may include an indented portion for receiving the pair of tongs 414 therein (e.g., one or more tabs on bottom surface 410a configured to receive the pair of tongs 414 and restrict their movement while coupled).

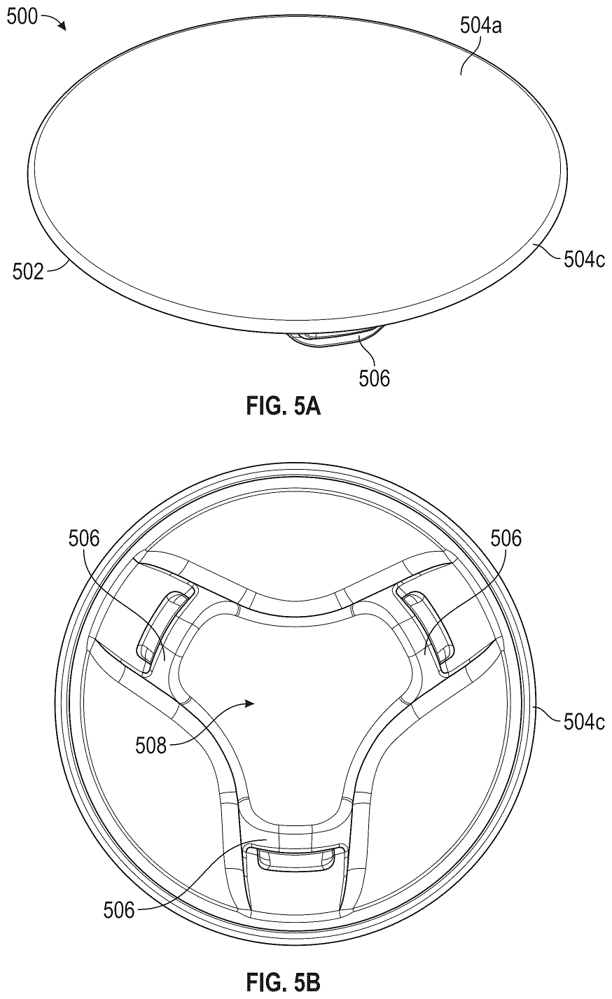

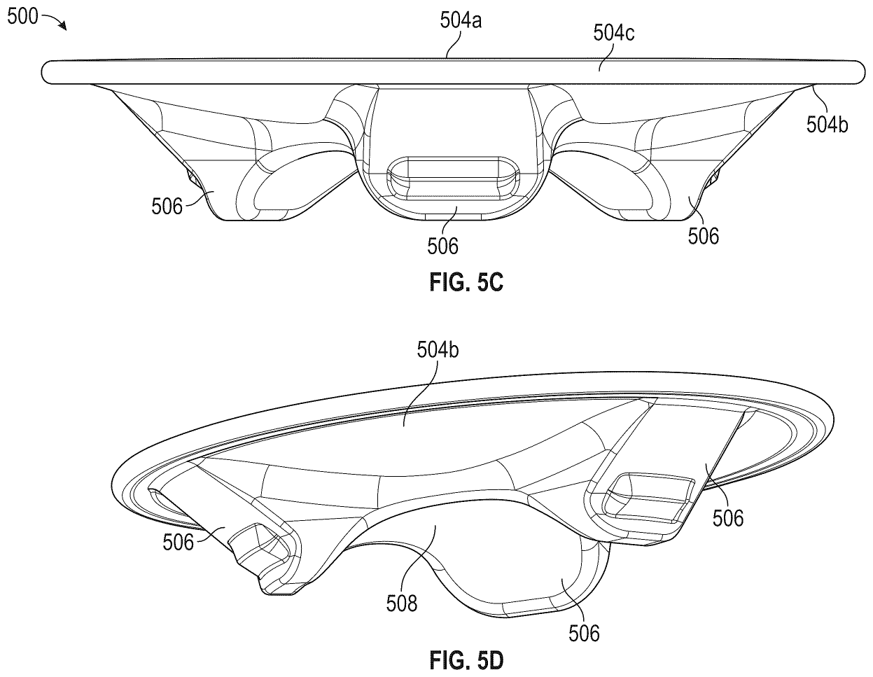

Referring now generally to FIGS. 5A-5D, a drain cover 500 for use with a drain hole in a sink basin or a wash basin may include a cover structure 502 having a top surface 504a separated from a bottom surface 504b by a perimeter edge 504c, and a plurality of interconnected tabs 506 couplable to the bottom surface 504b. Cover structure 502 may have a circular cross-section and a generally cylindrical shape as illustrated, or may have a rectangular cross-section and shape in a different example, or can have the geometry of other suitable regular polygons (e.g., spherical, triangular) or irregular polygons in other contemplated examples. The distance between top and bottom surfaces 504a,b defined by perimeter edge 504c is generally in the range of 1/64 inches to 1 inch, though other suitable measurements can be used for cover structure 502. Cover structure 502 generally has a diameter equal to or greater than the diameter of a drain hole in a wash basin or a sink basin (i.e., a diameter of a few inches, for example).

The plurality of interconnected tabs 506 may comprise three individual tabs 506 connected together as illustrated in the figures, or may comprise more than or less than three tabs 506 in other contemplated examples. Each of the plurality of interconnected tabs 506 may be oriented 120 degrees apart in a circular formation when three tabs 506 are used with drain cover 500, or 90 degrees apart when four tabs are used, for example. Plurality of interconnected tabs 506 may connect at a middle portion 508 that is generally concave with respect to a drain hole when drain cover 500 is inserted therein. In a contemplated example, each of the plurality of interconnected tabs 506 may be removable from the bottom surface 504b for replacement with new tabs 506.

In use, the plurality of interconnected tabs 506 may be inserted into a drain hole with the bottom surface 504b of the cover structure 502 covering the drain hole when the tabs 506 are inserted. Given the concavity of the middle portion 508, debris and fluids may still flow through the openings defined between the individual tabs 506 and into the drain hole for final disposal. Drain cover 500 thus functions as an accessible cover for drain holes rather than a plug which blocks all debris and fluids from exiting the wash or sink basin. Drain cover 500 may be manufactured from a variety of materials including, but not limited to, polymers such as acrylonitrile butadiene styrene (ABS), metals such as stainless steel, ceramics, or combinations thereof such as an ABS material body with a stainless-steel wrap over the body.

Referring now generally to FIGS. 6A-6I, a workstation sink system 600 may include a faucet 610 proximate a basin 640, and one or more accessories 650 configured for use with the basin 640 and/or a countertop proximate the faucet 610 and the basin 640. Faucet 610 may be any standard faucet known to one of ordinary skill in the art, such as a compression washer faucet, a cartridge faucet, a disc faucet, a ball faucet, a motion-activated faucet, or a touch-activated faucet, for example. Basin 640 may be any standard basin known to one of ordinary skill in the art, such as a basin used with an apron-front sink or a basin used with an undermount sink, for example. Basin 640 may have a length ranging from 23 inches to 44 inches, for example, to match the length of the one or more accessories 650 used therein. Further, basin 640 can have rounded corners 602 or ledges for ease of cleaning. In examples, each accessory 650 is configured to rest on corners 602 such that accessory 650 is suspended in basin 640. In some examples (not shown), basin 640 can include multiple stepped ledges or floating ledges at different heights for supporting accessories at different heights within basin 640.

In an example, basin 640 can comprise an undermount sink that is mounted via a rim or flange (not shown) to an undersurface of deck D. In other examples, basin 640 can comprise an overmount sink that mounts via a rim or flange to an upper surfacer of deck D.

As illustrated throughout the figures, the one or more accessories 650 may include: a wood cutting board 652 for cutting and storing food items; a drain board 654 having a plurality of openings for receiving debris or fluids; a colander 656 (which may be identical to colander 300); a wash basin 658, with or without a drain hole, for washing items such as food and dishes; a drain cover 660 for use with the wash basin 658 or a sink basin; a polymer cutting board 662 made from polypropylene or polyethylene, for example, for cutting and storing food items; a marble cutting board 664 for cutting and storing food items; one or more nestable prep bowls 666 for storing items such as food, the one or more prep bowls 666 being configured for side-by-side and/or nesting use in a sink basin; a bucket frame 668 for receiving a bucket 670a (which may be identical to bucket 400) in a sink basin; a lid 670b and pair of tongs 670c (which may be identical to lid 408 and pair of tongs 414) for use with the bucket 670a; a first sink cover 672 (which may be identical to first sink cover 100); and a second sink cover 674 (which may be identical to second sink cover 200).

In examples, accessories such as colander 656, wash basin 658, drain board 654, prep bowls 666, and others can include one or more flanges 651 on one or more sides of a top perimeter thereof for resting on corner 602. Other accessories, such as planar accessories like cutting boards 652, 662, and covers 672, 674 can rest on ledge 602 and/or cover the accessories resting on ledge 602 via flange 651.

The one or more accessories 650 may further include: a basin rack 676 for use within a sink basin; a sink cover with pass-through grate 678 for use over a sink basin; a roll-up rack 680 for drying and storing items; a squeegee 682 for cleaning kitchen surfaces; a scraper 684 for scraping debris off dishes or kitchen countertop surfaces; a standard utility rack 686 for drying and storing dishes and other kitchen utensils; a first universal cutting board 688 for cutting and storing food items; a second universal cutting board 690 for cutting and storing food items; a saddle utility rack 692 for drying and storing dishes and other kitchen utensils; and a saddle utility bar 694 for drying and storing dishes and other kitchen utensils.

In a contemplated example, the one or more accessories 650, independent or together with the faucet 610 and the basin 640, may form a kit for use in a kitchen setting. The one or more accessories 650 may be used in several different combinations suitable to the needs of the user. Example combinations include: the wood cutting board 652 with the wash basin 658 as illustrated in FIG. 6B; the wood cutting board 652 with the drain board 654, the colander 656, and the wash basin 658 as illustrated in FIG. 6C; the wood cutting board 652 with the colander 656, several prep bowls 666, and a basin rack as illustrated in FIG. 6D; the wood cutting board 652 with the colander 656, the polymer cutting board 662, and several prep bowls 666 as illustrated in FIG. 6E; the drain board 654 with the wash basin 658, the basin rack 676, and the scraper 684 as illustrated in FIG. 6F; the drain board 654 with the colander 656, the basin rack 676, and the scraper 684 as illustrated in FIG. 6G; the marble cutting board 664 with the bucket frame 668 containing a bucket 670a filled with ice and a bottle, and a first sink cover 672 as illustrated in FIG. 6H; and a marble cutting board 664 with a first sink cover 672 as illustrated in FIG. 6I. The present disclosure contemplates use of the one or more accessories 650 in any combination so long as there is sufficient space in the sink basin and on the neighboring countertops and ledges for receiving accessories 650.

Referring now to FIG. 7, a workstation sink system 700 may include a faucet 710 and a basin 740 having a drain hole 742 and rounded edges 744 that form an angle of exactly or approximately 90 degrees (i.e., each rounded edge 744 is formed with a small radius). Workstation sink system 700 has many similarities to workstation sink system 600, and for simplicity the description of common components is not repeated entirely herein. Like reference numerals and feature names may designate like features names throughout that are corresponding or analogous. Workstation sink system 700 may include the same geometrical configurations, orientations, shapes, measurements, materials, and accessories as workstation sink system 600. For example, workstation sink system 700 may include one or more accessories (not depicted) matching the one or more accessories 650 of workstation sink system 600. In a contemplated example, basin 740 may be formed of NEOROC which is a granite composite material (i.e., a mixture of natural stone and resin) manufactured by Kohler Corporation. Other suitable materials for basin 740 are contemplated by the present disclosure. In contemplated examples, basin 740 may have a length ranging from 18 inches to 33 inches, for example a length of 27 inches or 30 inches.

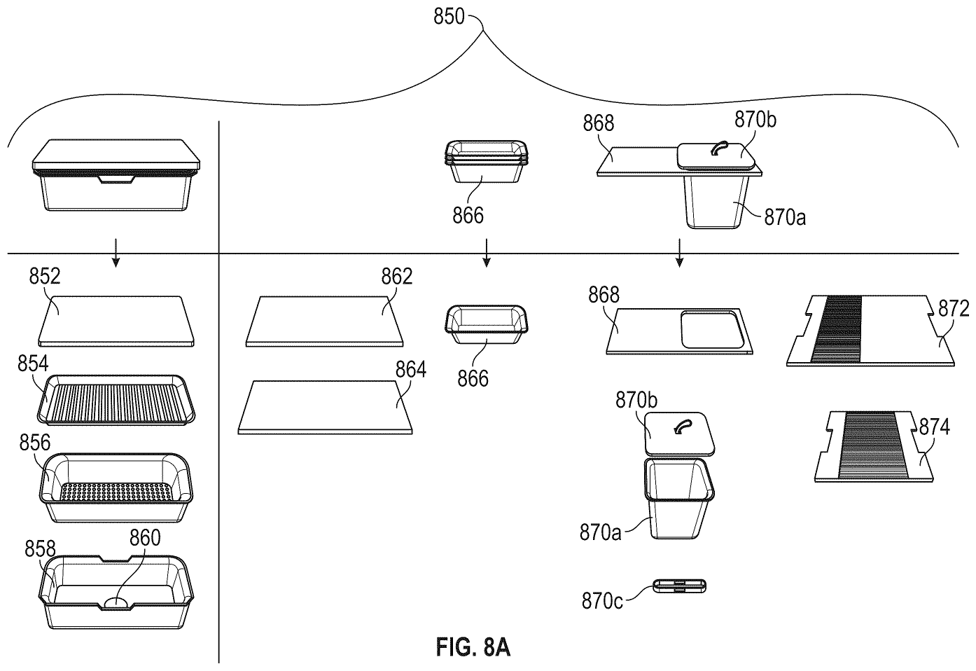

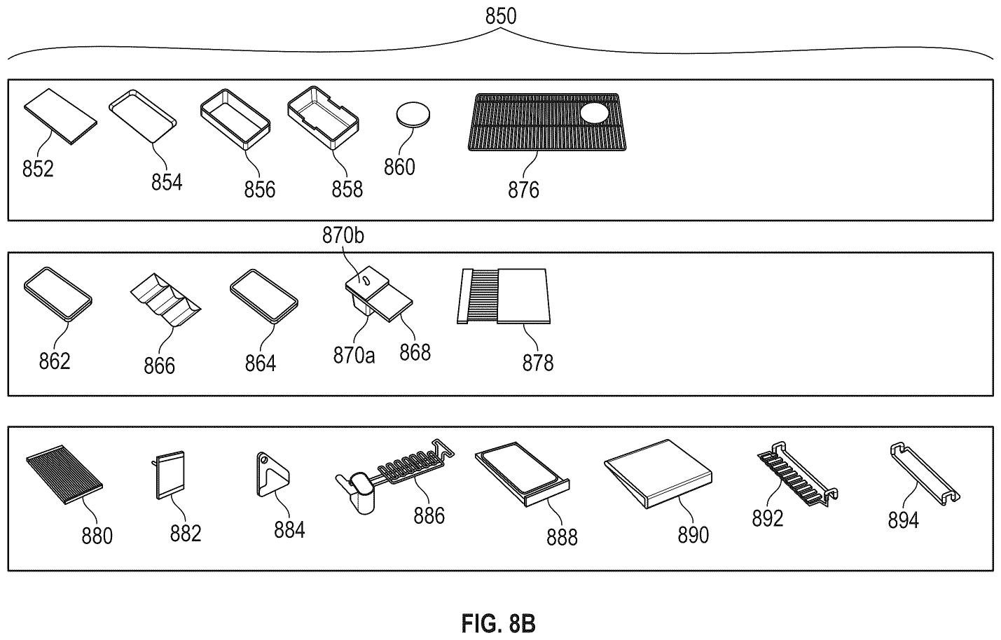

Referring now generally to FIGS. 8A and 8B, a workstation sink accessory kit 850 may include a wood cutting board 852, a drying rack 854, a colander 856, a wash basin 858 with or without a drain hole, a drain cover 860, a polymer cutting board 862, a marble cutting board 864, one or more nestable prep bowls 866, a bucket frame 868, a bucket 870a having a lid 870b and a pair of tongs 870c, a first sink cover 872, a second sink cover 874, a basin rack 876, a sink cover with pass-through grate 878, a roll-up rack 880, a squeegee 882, a scraper 884, a standard utility rack 886, a first universal cutting board 888, a second universal cutting board 890, a saddle utility rack 892, and a saddle utility bar 894. Workstation sink accessory kit 850 has many similarities to the one or more accessories 650 of workstation sink system 600, and for simplicity the description of common components is not repeated entirely herein. Like reference numerals and feature names may designate like features names throughout that are corresponding or analogous.

Two or more individual items in workstation accessory kit 850 may be provided to a user for subsequent combination and use in a kitchen setting. The individual items in workstation accessory kit 850 may be packaged together and combined in any suitable manner to fit the needs of the user (e.g., prepping food and drink items, storing food and drink items, entertaining guests, cleaning dishes and kitchen utensils, etc.).

The disclosure may be embodied in other specific forms without departing from the essential attributes. Therefore, the illustrated examples should be considered illustrative and not restrictive in all respects. Any claims provided herein are to ensure adequacy of the present application for establishing foreign priority and for no other purpose.

Various examples of systems, devices, and methods have been described herein. These examples are given only be way of example and are not intended to limit the scope of the claimed disclosures. It should be appreciated, moreover, that the various features of the examples that have been described may be combined in various ways to produce numerous additional examples. Moreover, while various material, dimensions, shapes, configurations, locations, etc. have been described for use with disclosed examples, others besides those disclosed may be utilized without exceeding the scope of the claimed disclosures.

Persons of ordinary skill in the relevant arts will recognize that the subject matter hereof may comprise fewer features than illustrated in any individual example described above. The examples described herein are not meant to be an exhaustive presentation of the ways in which the various features of the subject matter hereof may be combined. Accordingly, the examples are not mutually exclusive combinations of features; rather, the various examples can comprise a combination of different individual features selected from different individual examples, as understood be persons of ordinary skill in the art. Moreover, elements described with respect to one example can be implemented in other examples even when not described in such examples unless otherwise noted.

Any incorporation of reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112 (f) are not to be invoked unless the specific terms “means for” or “step for” are recited in a claim.

1-11. (canceled)

12. A workstation sink accessory kit for use with a sink system including a sink basin and faucet, the kit comprising:
a plurality of accessories, each accessory being mountable and removably positionable within the sink basin such that the accessory is suspended within the basin, wherein the accessory is selected from the group consisting of a sink cover, cutting board, a colander, an ice bucket assembly, a wash basin, a prep bowl, a bucket, a bucket frame for receiving the bucket, a drain board, a drying rack, a roll-up rack, a saddle utility rack, a saddle utility bar, and combinations thereof.

13. The workstation sink accessory kit of claim 12, wherein at least one accessory of the plurality of accessories includes a flange extending from a top perimeter thereof, the flange being configured to rest on a ledge of the sink basin such that the accessory is suspended within the basin.

14. The workstation sink accessory kit of claim 12, wherein the plurality of accessories comprises a plurality of nestable prep bowls and at least one cutting board.

15. The workstation sink accessory kit of claim 12, wherein the plurality of accessories comprises a bucket frame and a bucket, wherein the bucket frame includes structure defining an opening configured to receive and support the bucket within such that the bucket extends below the bucket frame within the sink basin.

16. The workstation sink accessory kit of claim 15, wherein the bucket comprises an ice bucket assembly including a bucket, a lid, and tongs, wherein a bottom side of the lid comprises structure for receiving and removably securing the tongs thereto.

17. The workstation sink accessory kit of claim 12, wherein the plurality of accessories comprises a nestable accessory assembly, the nestable accessory assembly comprising a wash basin, and at least one of a colander nestable within the wash basin, a drying rack nestable within the wash basin or the colander if present, and a cutting board dimensioned to cover the wash basin.

18-20. (canceled)

21. A workstation sink accessory kit for use with a sink basin, the kit comprising:
a plurality of accessories, each accessory being mountable and removably positionable within the sink basin such that the accessory is at least partially suspended within the basin,
wherein the plurality of accessories are configured to rest on an inner surface of the sink basin when at least partially suspended therein.

22. The workstation sink accessory kit of claim 21, wherein the plurality of accessories comprises a drain board defining a plurality of openings for receiving fluids and debris, the drain board further defining a workspace configured to receive items.

23. The workstation sink accessory kit of claim 21, wherein the plurality of accessories comprises a colander having one or more ridges configured to receive items, the colander defining at least one opening for receiving fluids and debris.

24. The workstation sink accessory kit of claim 23, wherein the items comprise one or more prep bowls configured for side-by-side or nesting use in the colander.

25. The workstation sink accessory kit of claim 21, wherein the plurality of accessories comprises a wash basin and a cutting board, the cutting board being positionable over the wash basin.

26. The workstation sink accessory kit of claim 21, wherein the plurality of accessories comprises one or more nestable prep bowls configured for side-by-side placement in the sink basin.

27. The workstation sink accessory kit of claim 21, wherein the plurality of accessories comprises a bucket frame and a bucket assembly, the bucket frame defining an opening for receiving at least a portion of the bucket assembly.

28. The workstation sink accessory kit of claim 27, wherein the bucket assembly comprises a bucket, a lid, and tongs, and wherein a bottom side of the lid comprises structure for receiving and removably securing the tongs thereto.

29. The workstation sink accessory kit of claim 21, wherein the plurality of accessories comprises a first sink cover and a second sink cover, and wherein the first sink cover and the second sink cover are positioned along the sink basin to form a workspace thereon.

30. A workstation sink system, the system comprising:
a sink basin having two or more ledges formed along at least one sidewall, the two or more ledges positioned at different heights of the sink basin along the at least one sidewall; and
a plurality of accessories removably mounted on at least one of the two or more ledges, such that the plurality of accessories are suspended at least partially within the sink basin, wherein at least one first accessory of the plurality of accessories is nestable within at least one second accessory of the plurality of accessories.

31. The workstation sink system of claim 30, wherein the plurality of accessories are movable along the two or more ledges of the sink basin.

32. The workstation sink system of claim 30, wherein the at least one second accessory comprises a colander or a wash basin, and wherein the at least one first accessory comprises one or more prep bowls.

33. The workstation sink system of claim 30, wherein the plurality of accessories comprise:
a first sink cover arranged along at least one of the two or more ledges, the first sink cover defining a plurality of openings for receiving fluids and debris, the first sink cover further defining a workspace for receiving items;
a bucket frame arranged along at least one of the two or more ledges, the bucket frame defining an opening and a workspace for receiving items; and
a bucket assembly at least partially received through the opening of the bucket frame, the bucket assembly comprising a bucket, a lid, and tongs, wherein a bottom side of the lid comprises structure for receiving and removably securing the tongs thereto.

34. The workstation sink system of claim 30, wherein the plurality of accessories comprise:
a wash basin defining a drain hole;
a colander at least partially nestable within the wash basin, the colander defining one or more ridges for receiving items, the colander further defining at least one opening for receiving fluids and debris, wherein the at least one opening of the colander is in fluid communication with the wash basin;
a drying rack at least partially nestable within the colander, the drying rack defining at least one opening for receiving fluids and debris, and wherein the at least one opening of the drying rack is in fluid communication with the colander; and
a cutting board arranged along the drying rack,
wherein the wash basin, the colander, the drying rack, and the cutting board are each arranged along at least one of the two or more ledges defined by the sink basin, and wherein fluids and debris can flow from the drying rack through the colander and the drain hole of the wash basin.
